(19) United States
(12) Patent Application Publication
(10) Pub. No.: US 2005/0145212 A1
(43) Pub. Date: Jul. 7, 2005

(54) Intake and exhaust system for engine

(75) Inventors: Masayuki Komuro, Tokyo (JP); Mitsugi Chonan, Tokyo (JP); Shigeru Abe, Tokyo (JP); Takeshi Osaku, Tokyo (JP)

Correspondence Address: SMITH, GAMBRELL & RUSSELL, LLP, 1850 M STREET, N.W., SUITE 800, WASHINGTON, DC, 20036, US

(73) Assignee: Fuji Jukogyo Kabushiki Kaisha

(21) Appl. No.: 11/022,835

(22) Filed: Dec. 28, 2004

(30) Foreign Application Priority Data
Jan. 5, 2004 (JP) 2004-527

(51) Int. Cl. F02B 31/00; F02F 1/00

(52) U.S. Cl. 123/193.5

(57) ABSTRACT

An intake port for guiding new intake air into a combustion chamber of a cylinder and an exhaust port for discharging exhaust combustion gas from the combustion chamber to the outside, are formed in a cylinder head mounted on the cylinder for housing a piston movably in a reciprocating manner. The intake port is opened/closed by intake valve, and the exhaust port is opened/closed by exhaust valve. Openings of the intake and exhaust ports at the combustion chamber side are formed to be displaced toward central portion of the combustion chamber. An inclining angle of the intake valve formed between the central axis of the intake valve and the central axis of a cylindrical bore of the cylinder is set larger than an inclining angle of the exhaust valve, formed between the central axis of the exhaust valve and the central axis of the cylindrical bore of the cylinder, and a bulge portion is formed on the inner surface of the intake port, oppositely to a valve guide for guiding movably the intake valve of the intake port.

### TECHNICAL FIELD OF THE INVENTION

The present invention relates to an intake and exhaust system for an engine, which improves a charging efficiency of new intake air in a combustion chamber of the engine.

### BACKGROUND OF THE INVENTION

A four-cycle engine includes a cylinder for housing a piston movably in a reciprocating manner, and a cylinder head fixed to the cylinder. An intake port for supplying air or an air-fuel mixture into a combustion chamber of the engine and an exhaust port for discharging exhaust combustion gas from the combustion chamber to the outside are formed in the cylinder head. An intake valve for opening and closing the intake port and an exhaust valve for opening and closing the exhaust port are provided in the cylinder head, and these intake and exhaust valves are driven synchronously with a rotation of a crankshaft. As a valve operating mechanism for driving the intake and exhaust valves, there is an OHC (Over-Head Camshaft) type in which a camshaft having a valve operating cam is disposed in a cylinder head, and the OHC type valve operating mechanism has a direct drive type for driving an intake valve and an exhaust valve directly by valve operating cams, respectively, and a rocker arm type for driving an intake valve and an exhaust valve via a rocker arm. There are one type having a valve operating cam for driving an intake valve and a valve operating cam for driving an exhaust valve at one camshaft, and the other type having a camshaft for driving an intake valve and another camshaft for driving an exhaust valve, in the rocker arm type. Japanese Patent Application Laid-Open Publication No. 6-229210 and Japan Patent Application Laid-Open Application Publication No. 7-102932 disclose an SOHC (Single Over-Head Camshaft) engine of the type that valve operating cams for both intake and exhaust valves are provided at one camshaft.

In a two-valve type cylinder head having an intake valve and an exhaust valve provided in one cylinder head, corresponding to a combustion chamber, when a valve included angle formed between a central axis of the intake valve and a central axis of the exhaust valve, is reduced, a size of the combustion chamber in a piston stroke direction can be shortened. Therefore, the compression ratio can be increased by decreasing a volume of the combustion chamber. If the compression ratio can be increased, an output, or power, of the engine can be increased. Accordingly, when the output of the engine is considered, it is limited to increase the valve included angle.

On the other hand, in order to improve the output of the engine, it is desirable to raise a charging efficiency of new intake air, that is, air and an air-fuel mixture in the combustion chamber of the engine. It should be noted that the charging efficiency is a ratio of the new intake air to a mass of the new air occupying a volume of a total stroke of a piston in the cylinder in a standard state. Thus, the charging efficiency is affected by not only opening and closing timing of the intake and exhaust valves but also a pressure loss of an intake passage from an air cleaner to the combustion chamber through the intake port of the cylinder head.

Various kinds experiments have been conducted so as to improve the output of the engine by improving the charging efficiency. In the experiments, it has been discovered that the charging efficiency is changed according to a shape of the intake port of the cylinder head, and a valve guide for guiding a movement of the intake valve affects the new intake air flowing through the intake port so that the charging efficiency changes depending on a stream of the new intake air in the circumference of the valve guide.

### SUMMARY OF THE INVENTION

Accordingly, it is an object of the present invention to improve an output of an engine by raising a charging efficiency of new intake air in a combustion chamber of the engine.

The intake and exhaust system for an engine according to the present invention is the system for the engine having a cylinder head mounted on a cylinder for housing a piston movably in a reciprocating manner and including an intake port for guiding new intake air into a combustion chamber of the cylinder and an exhaust port for discharging exhaust combustion gas from the combustion chamber to the outside, comprising: an intake valve for opening and closing the intake port; an exhaust valve for opening and closing the exhaust port; and the intake port and the exhaust port respectively having openings of the combustion chamber side, which are formed toward a central portion of the combustion chamber, wherein an inclining angle of a central axis of the intake valve to a bore central axis of a cylinder bore is set larger than that of a central axis of the exhaust valve to the central axis of the cylinder bore, and wherein a bulge portion is formed on an inner surface of the intake port opposed to a valve guide of a portion projecting into the intake port for guiding movably the intake valve.

The intake and exhaust system for the engine according to the present invention further comprises a camshaft having a valve operating cam and rotatably driven by a crankshaft; and a rocker shaft rotatably supporting an intake side rocker arm, driven by the valve operating cam for opening and closing the intake valve, and an exhaust side rocker arm, driven by the valve operating cam for opening and closing the exhaust valve.

According to the present invention, openings of an intake port and of an exhaust port at the combustion chamber side are formed by displacing the openings toward a central portion of the combustion chamber. In addition, an inclining angle of the intake valve is set larger than that of the exhaust valve. Therefore, as compared with the case that the inclining angles of the intake valve and the exhaust valve are made symmetrical, a bending angle of the intake port in the cylinder head can be reduced, and, therefore, a passage resistance of the new intake air can be decreased. A bulge portion is formed on an inner wall surface of the intake port, opposed to a valve guide of the intake valve, and thereby the passage resistance of the new intake air can be reduced. The ventilating resistance of the new intake air can be reduced, and the output of the engine can be thereby improved by raising the charging efficiency of the new intake air.

### BRIEF DESCRIPTION OF THE DRAWINGS

FIG. 1 is a cross-sectional view showing an intake and exhaust system of an engine according to an embodiment of the present invention; and

FIG. 2 is a plan view of a cylinder head shown in FIG. 1.

### DESCRIPTION OF THE PREFERRED EMBODIMENTS

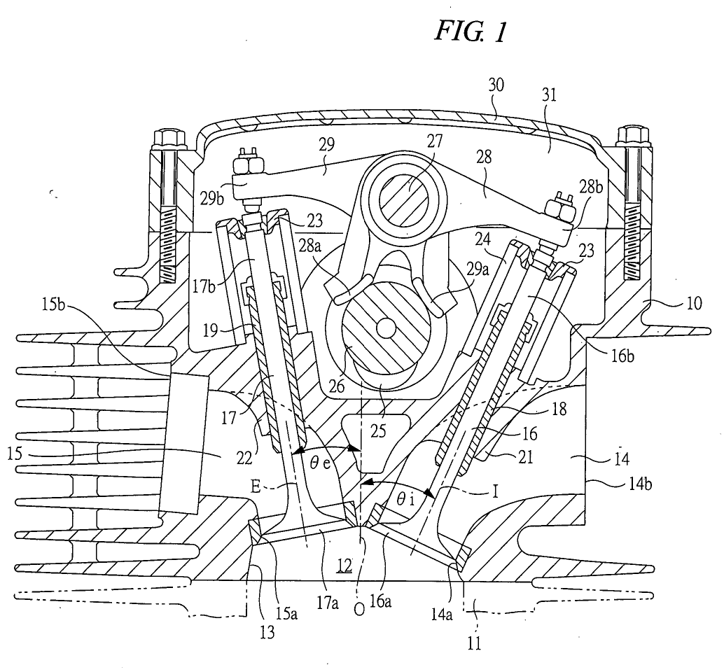

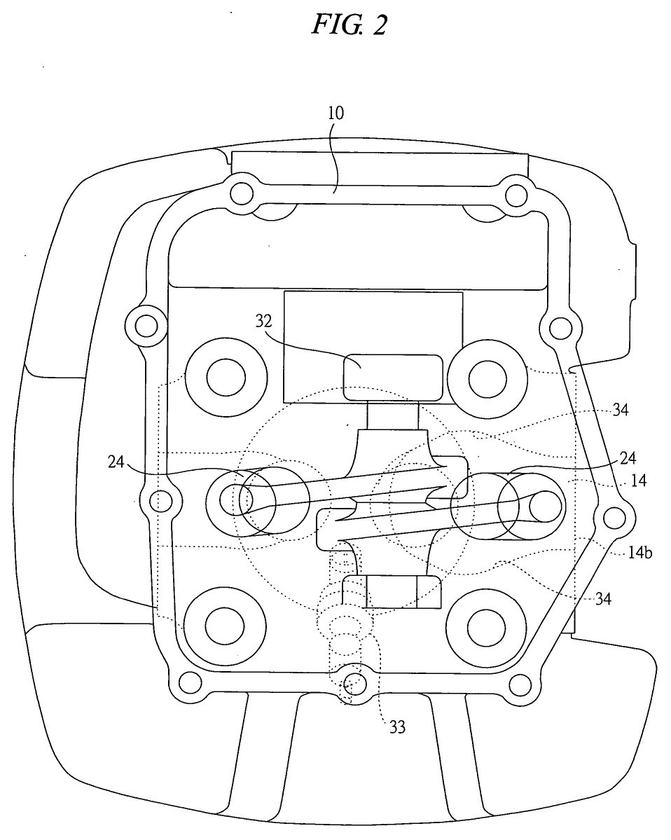

Now, the present invention will be described in greater detail by referring to the accompanying drawings that illustrate preferred embodiment of the invention. FIG. 1 is a cross-sectional view showing an intake and exhaust system of an engine according to the embodiment of the invention, and FIG. 2 is a plan view of a cylinder head shown in FIG. 1.

A cylinder head 10 is adapted to be mounted on a cylinder 11. A piston, not shown, is housed in the cylinder 11 so as to be movable in a cylinder bore of the cylinder 11 in a reciprocating manner. An engine, shown in FIGS. 1 and 2, is a general-purpose engine having a single cylinder. A single cylinder bore is formed in the cylinder 11. However, in the case of an engine having a plurality of cylinders, a plurality of cylinder bores are formed in the cylinder 11. A combustion chamber 12 is partitioned by and formed of the cylinder head 10 and the cylinder 11. A recess portion 13 formed on the cylinder head 10 forms a part of the combustion chamber 12.

One intake port 14 for guiding new intake air into the combustion chamber 12 and one exhaust port 15 for discharging exhaust combustion gas from the combustion chamber 12 to the outside, are formed in the cylinder head 10. Openings 14a and 15a of the intake port 14 and the exhaust port 15 to the combustion chamber 12 are formed adjacent to each other and also formed by displacing the openings 14a and 15a toward a central portion of the combustion chamber 12. Openings 14b and 15b of the intake port 14 and the exhaust port 15 of the cylinder head 10 to the outside are respectively formed at opposite side surfaces of the cylinder head 10. An intake valve 16 for opening and closing the intake port 14 and an exhaust valve 17 for opening and closing the exhaust port 15 are mounted in the cylinder head 10. These intake and exhaust valves 16 and 17 respectively has valve bodies 16a and 17a and valve stems 16b and 17b.

The intake and exhaust valves 16 and 17 respectively have valve guides 18 and 19 mounted in the cylinder head 10 so as to guide axially movably the valve stems 16b and 17b of the intake and exhaust valves 16 and 17 through the valve guides 18 and 19. Guide supporting portions 21 and 22 are formed in the cylinder head 10 with respect to the respective valve guides 18 and 19 so as to be expanding in the intake port 14 and the exhaust port 15 so as to partly support the valve guides 18 and 19. Retainers 23 are respectively mounted at the ends of the valve stems 16b and 17b so as to apply spring forces to the intake valve 16 and the exhaust valve 17 in the direction for closing the intake and exhaust ports 14 and 15 of the intake and exhaust valves 16 and 17, and valve coiled springs 24 are respectively mounted between the retainers 23 and the cylinder head 10. In order to drive the intake valve 16 and the exhaust valve 17, a camshaft 26 having a valve operating cam 25 formed thereon, is mounted rotatably in the cylinder head 10, and a rocker arm 28 of the intake side for driving to open and close the intake valve 16 and a rocker arm 29 of the exhaust side for driving to open and close the exhaust valve 17, are mounted pivotally at a rocker shaft 27 which is rotatably mounted in the cylinder head 10 being parallel to the camshaft 26.

The rocker arms 28 and 29 respectively have slide portions 28a and 29a slidably contacted with the valve operating cam 25, and drive ends 28b and 29b engaged with the valve stems 16b and 17b. The rocker arm 28 of the intake side is driven by the valve operating cam 25 to open and close the intake valve 16, and the rocker arm 29 of the exhaust side is driven by the cam 25 to open or close the exhaust valve 17. A sprocket, not shown, is adapted to be mounted at the camshaft 26. A chain is adapted to be chained between this sprocket and a sprocket mounted at a crankshaft (not shown), and the camshaft 26 is rotatably driven by the crankshaft.

A head cover 30 is adapted to be mounted on the cylinder head 10. A valve operating chamber 31 for housing the valve mechanism, which has the camshaft 26 and the rocker arms 28, 29, etc., is closed by the head cover 30. FIG. 2 shows the cylinder head 10 of the state that the valve operating mechanism is removed. Bearing units 32 each for supporting rotatably the camshaft 26 and for fixing the rocker shaft 27 are respectively provided in the cylinder head 10. Further, an ignition plug 33 is mounted in the cylinder head 10.

As shown in FIG. 1, an inclining angle θi of the intake valve 16 is set to a larger angle than an inclining angle θe of the exhaust valve 17, wherein θi designates an inclining angle of the intake valve 16 formed between the central axis O of the cylinder bore of the cylinder and the central axis I of the intake valve 16, and θe designates an inclining angle of the exhaust valve 17 formed between the central axis O of the cylinder bore and the central axis E of the exhaust valve 17. As in the case shown in FIG. 1, the inclining angle θi of the intake valve 16 is set in a range of about 20 to 30 degrees, and the inclining angle θe of the exhaust valve 17 is in a range of about 10 to 20 degrees. In addition, the inclining angle θi is set to about twice as large as the inclining angle θe. As having been described in the foregoing, when the inclining angle θi is set to a larger angle than the inclining angle θe, the intake and exhaust valves 16 and 17 of a valve operating system are provided in a structure that the intake and exhaust valves 16 and 17 are generally inclined toward the opening 14b of the intake port 14 without increasing the valve included angle formed between a central axis of the intake valve 16 and a central axis of the exhaust valve 17. In this manner, a bending angle of the intake port 14 between the openings 14a and 14b becomes smaller than that in the case that both the inclining angles θi and θe of the intake valve 16 and the exhaust valve 17 are substantially the same and the intake and exhaust valves 16 and 17 are disposed in a symmetrical manner. When the bending angle of the intake port 14 becomes small, the ventilating resistance of the new intake air becomes small so that the charging efficiency can be improved.

As shown in FIG. 1, the guide supporting portion 21 expands in the intake port 14. As shown in FIG. 2, the recess portions, that is, bulge portions 34 are formed at both side portions opposed to the guide supporting portion 21 on the inner surface of the intake port 14. The bulge portions 34 are formed in the intake port 14 so that the intake port 14 is thereby locally increased in shape in a lateral size of the inner surface. In this manner, the bulge portions 34 are formed oppositely to the valve guide 18 in the intake port 14 so that the ventilating resistance of the new intake air flowing through the intake port 14 becomes low with the result that the charging efficiency can be improved.

When the intake and exhaust system in which the inclining angle θi is set larger than the inclining angle θe and the bulge portions 34 are formed on the inner surface of the intake port 14, as shown in FIGS. 1 and 2, and an intake and exhaust system in which conventionally both the inclining angles θi and θe (valve included angle) are made substantially the same, the intake and exhaust valves 16 and 17 are disposed in a symmetrical manner and the bulge portions are not provided in the intake port 14 as a prior art, were comparatively experimented, it has been found that the charging efficiency of the new intake air of the intake and exhaust system according to the present invention has been improved by about 6% as compared with the conventional intake and exhaust system. Furthermore, since the inclining angle of the intake valve 16 is set larger than that of the exhaust valve 17 without increasing the valve included angle formed between the intake and exhaust valves 16 and 17, the desired compression radio can be maintained. Further, the output of the engine can be improved by the setting of the inclining angles θi and θe and by the formation of the bulge portions 34.

The present invention is not limited to the embodiment as having been described in the foregoing, but can be variously changed without departing from the subject matter of the present invention. For example, the intake and exhaust device of the engine as shown in the drawings is applied to the general-purpose engine, but may also be applied to an automotive engine.

The entire disclosure of Japanese Patent Application No. 2004-527 filed on Jan. 5, 2004 including specification, claims, drawings and summary is incorporated herein by reference in its entirety.

1. An intake and exhaust system for an engine having a cylinder head mounted on a cylinder for housing a piston movably in a reciprocating manner and including an intake port for guiding new intake air into a combustion chamber of the cylinder and an exhaust port for discharging exhaust combustion gas from the combustion chamber to the outside, comprising:
an intake valve for opening and closing the intake port;
an exhaust valve for opening and closing the exhaust port; and
the intake port and the exhaust port respectively having openings of the combustion chamber side, which are formed toward a central portion of the combustion chamber,
wherein an inclining angle of a central axis of the intake valve to a bore central axis of a cylinder bore is set larger than that of a central axis of the exhaust valve to the central axis of the cylinder bore, and
wherein a bulge portion is formed on an inner surface of the intake port opposed to a valve guide of a portion projecting into the intake port for guiding movably the intake valve.

2. The intake and exhaust system for the engine according to claim 1, further comprising:
a camshaft having a valve operating cam and rotatably driven by a crankshaft; and
a rocker shaft rotatably supporting an intake side rocker arm, driven by the valve operating cam for opening and closing the intake valve, and an exhaust side rocker arm, driven by the valve operating cam for opening and closing the exhaust valve.
